(19) United States
(12) Patent Application Publication
(10) Pub. No.: US 2009/0255872 A1
(43) Pub. Date: Oct. 15, 2009

(54) AERATING DEVICE FOR A WATER FILTERING SYSTEM WITH IMMERSED MEMBRANES, INCLUDING A FLOOR PROVIDED WITH MEANS FOR INJECTING A GAS AND AT LEAST ONE PRESSURE BALANCING SYSTEM

(75) Inventors: Aurelien Busnot, Montmorency (FR); Etienne Brois, Corne (FR)

Correspondence Address: COATS & BENNETT, PLLC, 1400 Crescent Green, Suite 300, Cary, NC, 27518, US

(73) Assignee: OTV SA, Saint-Maurice Cedex (FR)

(21) Appl. No.: 12/298,605

(22) PCT Filed: May 18, 2007
(86) PCT No.: PCT/EP2007/054815

§ 371 Date: Jan. 12, 2009

(30) Foreign Application Priority Data
May 23, 2006 (FR) 0604616

(51) Int. Cl. B01D 61/20; B01D 61/18; C02F 1/44; C02F 3/02

(52) U.S. Cl. 210/636; 210/321.69; 210/151

(57) ABSTRACT

An aerating device for a water treatment system includes an upper and lower chamber separated by a partition. The upper chamber includes a plurality of immersed membranes for removing contaminants from the water. The lower chamber includes a gas inlet and a water inlet for directing gas and water to be treated respectively into the lower chamber. The water inlet is disposed at a lower depth in the lower chamber than the gas inlet. A plurality of air dispersers extend through the partition from the lower chamber to the upper chamber for directing gas from the lower chamber to the upper chamber to aerate the immersed membranes. Finally, the device includes at least one passageway extending through the partition from the lower chamber to the upper chamber for directing water to be treated from the lower chamber to the upper chamber.

The invention relates to the field of water treatment. More specifically, the invention relates to a device for injecting a gas for unclogging filtering membranes immersed in a medium to be filtered.

According to a known filtering technique, the filtering system comprises vertical immersed membranes grouped into generally cylindrical or parallelepipedic, or rectangular, shaped modules. Conventionally, these modules incorporate plane membranes or hollow fibre membranes made of organic materials, packed at least at one of the ends thereof.

The treated liquid is filtered under the effect of suction from the outside of the membrane towards the inside.

These membranes are conventionally micro-filtration or ultra-filtration membranes.

The invention is particularly applicable to devices in which the membranes are arranged in a vertical position, but is also applicable to filtering devices wherein the membranes are immersed in a horizontal position.

These immersed membrane systems are particularly used to treat water to be rendered fit for drinking, with a view to retaining the pollution in suspension in the water or to prevent the passage of microscopic animalcules (protozoa), such as cryptosporidium or giardia, bacteria and/or viruses, or to retain powdery reagents or catalysts such as activated carbon powder or alumina, which have been injected into the treatment line upstream from the membranes.

This type of membrane is also used in immersion in membrane bioreactors (frequently referred to as “MBRs”), as means to clarify wastewater treated by a suspended biomass in the reactor, and as a means to retain the biomass inside the reactor.

The membrane modules are frequently grouped together into racks or cassettes, with a support or common connections for all the rack or cassette modules.

In known immersed membrane filtering systems, a problem lies in the progressive clogging of the membranes by the materials to be filtered, referred to as sludge, particularly with respect to immersed membranes in a bioreactor containing activated sludge.

In fact, the membranes are gradually clogged by the sludge captured on the surface thereof, or even, in the case of severe clogging, by accumulations of sludge and/or fibrous materials trapped by the fibre bundle (in the case of hollow fibre membranes) or between the membrane elements (in the case of plane membranes).

This clogging requires unclogging actions, frequently carried out by means of back-filtration (or “back-washing”) by the permeate, with or without chemical reagent, or by means of chemical washing of the membranes.

Most frequently, to unclog the membranes and/or delay the clogging thereof, a gas (generally air) is injected, continuously or in a cyclical fashion, in the lower part of the membrane module.

The gas bubbles injected rise along the fibre or the plane membrane at a rate tending to limit the deposition of materials on the membrane, thus reducing the filtering membrane clogging rate.

This is due to the fact that the rising of the gas bubbles injected creates strong turbulence, more or less agitating the adjacent fibres, cleaning the fibres or the plane membranes mechanically by the action of the injected air, which eventually makes it possible to delay the clogging of the membranes.

Various methods have been proposed to perform the injection of such an unclogging gas.

According to a known technique, the gas is injected directly into a closed chamber located under a lower packing wherein bundles of hollow fibres are packed, the air being distributed between modules using a valve or a calibrated orifice, before entering openings provided in the lower packing of the fibre bundles.

The use of this system induces rapid clogging of the injection openings. In fact, each time the gas injection is stopped, part of the medium to be treated enters these openings, and the sludge fed in this way is dried by the gas on resumption of the injection, rapidly inducing the soiling or blockage of the openings.

According to another known technique, the medium to be filtered and the unclogging gas are both injected via openings provided in the lower packing of the bundles of hollow fibres.

This system offers the theoretical advantage of avoiding the drying of the sludge deposited in the openings, under the effect of the gas entering therein.

According to a further technique, the bundle of hollow fibres is immersed vertically in the medium to be filtered (for example, the activated sludge of an MBR) and the unclogging air is fed under each module via a pipe equipped with perforations enabling air flow.

The air injected under the modules enters the modules, and then rises inside the modules along the hollow fibres, before escaping via the sides or via similar orifices provided in the upper packing of the modules.

One drawback of the gas injection mode used in these techniques is that the air injection openings located in the base of the membrane bundle gradually become clogged due to the deposition of sludge (or large particles, fibres, etc. conveyed by the liquid to be treated), and in the sludge/air mixing zone.

Consequently, this phenomenon progressively induces poor distribution of the gas, unequally distributed at the base of each module or between the various modules and finally accelerating clogging of the parts of the bundle of fibres or plane plates poorly scavenged by the unclogging gas.

In order to remedy the abovementioned drawbacks, another solution described in the patent document published under the number FR-2 869 552 was proposed by the prior art.

According to this solution, the unclogging gas injection means are associated with anti-upflow means making it possible to prevent the contact of the liquid to be treated with the injection means.

These anti-upflow means may consist of:
a sleeve mounted in a tight manner on injection nozzles and displaying at least one elastically deformable passage wherein the contours separate when the clogging gas pressure exceeds a determined pressure in the nozzles and are contiguous when the unclogging gas pressure is less than this predetermined pressure;
a nozzle protection valve, said valve being mobile between an open gas injection position and a sealed position, the value being coupled with return means.

This solution is effective in theory.

In practice, the deformable material of the sleeve may be degraded in contact with the more or less corrosive constituents of the liquid to be treated. In this case, it may lose some its elasticity and may, in the long term, no longer fulfil the tightness and therefore protection function thereof with respect to the injection nozzles.

The valves, for their part, may be the subject of soiling which is liable to cause a loss of tightness when they are in the sealed position, which also induces, in the long term, a loss of efficiency with respect to the protection of the nozzles intended to be provided by the valves.

Therefore, it is observed that the function of these means is associated with a common aspect to sleeves and valves: the mobility of one of the parts thereof so that they change from a protection position to a position allowing the unclogging gas flow.

However, as demonstrated above, the use of mobile parts involves degradation risks of the function of the protection means including said mobile parts.

Moreover, the solution described as per FR-2 869 552 is particularly intended for filtering devices wherein the membranes are packed at least in a lower packing, the injection means being provided via said packing.

However, membrane packing is a specific technique and it may be desired to make use of another type of membrane filtering device design.

As a general rule, the membrane unclogging gas, which is essential for the proper operation of an immersed membrane method, represents a significant additional cost as it represents a large proportion of the energy consumption of a water treatment plant.

As described above, the majority of systems currently use perforated aeration ramps: the aeration orifices are generally liable to become blocked over time, requiring the frequently complex fitting of an aerator unclogging system.

In order to prevent this accumulation of solids, it is therefore preferable to retain a sufficiently large orifice size to prevent the blockage thereof, which may induce either higher air consumption, or less homogeneous air distribution.

According to another known drawback of the existing solutions, the sludge (mixed liquor) is poorly distributed in the reactors as it is generally fed via a single inlet into the reactor. In this case, a solution consists of using a large supply pipe. However, this proves to be a costly solution.

The aim of the invention is to remedy the drawbacks of the prior art.

More specifically, the aim of the invention is to propose a membrane aeration technique of an immersed water treatment system which does away with unclogging gas injection means efficiency loss phenomena encountered with the solutions according to the prior art.

The aim of the invention is also to provide such a technique wherein the reliability is sustainable.

The aim of the invention is also to provide such a filtering device enabling satisfactory distribution of the unclogging gas at the base of the membranes (hollow or plane fibres).

A further aim of the invention is to provide such a technique making it possible to envisage a reduction in the operating costs of immersed membrane bi ore actors.

A further aim of the invention is to provide such a filtering device which is simple in design and easy to use.

These aims, along with others which will emerge hereinafter, are achieved by means of the invention which relates to an aerating device for a water filtering system for an immersed membrane bioreactor designed to be installed substantially beneath said membranes characterised in that it comprises a floor separating an upper chamber wherein said membranes are immersed and a lower chamber comprising means for feeding a liquid to be treated and means for feeding an aerating gas, said floor being provided with a plurality of strainers and with at least one system for balancing pressures between said upper and lower chambers, and in that each strainer includes a substantially tubular element passing through said floor, protruding above said floor and having in its upper part at least one orifice, and an air chamber forming element mounted atop said upper part and covering the periphery of said upper part of said substantially tubular element.

In this way, by means of the invention, an aeration system is obtained wherein the strainers retain their efficiency in a sustainable manner due to the fact that their orifice is never in contact with the liquid to be treated.

In effect, as the liquid is not in contact with the orifices of the strainers by means of the covers containing the gas and isolating the strainer orifices, solid materials cannot be deposited thereon. Therefore, the blockage phenomena caused by these deposits are eliminated.

As the risk of blockage of the strainers is eliminated, or at the very least limited, it is possible to reduce the diameter of the strainer orifices and, as a result, the quantity of air distributed. In this way, while ensuring an efficiency at least equal to that of the prior solutions, it is possible to limit the energy consumption associated with the air distribution and therefore reduce the operating costs of the facility equipped according to the invention.

In addition, the use of a floor makes it possible to obtain improved distribution of the unclogging gas compared to the solutions according to the prior art.

Also, the optimisation of the unclogging gas distribution control helps control costs associated with energy usage for gas distribution.

Moreover, a device according to the invention also makes it possible to reduce the production costs of the aerating device and therefore of the reactor equipped therewith particularly compared to the perforated pipework or packing aeration systems mentioned above with reference to the prior art.

According to one advantageous solution, said means for feeding an aerating gas lead to said lower chamber, said means for feeding said liquid to be treated lead to a distant zone from said means for feeding an aerating gas and beneath same, said balancing system(s) comprising at least one tube protruding under the floor in the direction of said distant zone.

In this way, it is possible to obtain an air sheet under the floor, which particularly offers the advantage, during aeration, of preventing any liquid from rising via the strainers.

This air sheet disappears when the aeration is discontinued. However, the pressure balancing (by means of balancing tubes for example) makes it possible to retain a quantity of gas, trapped by the covers, around orifices of the strainers, preventing any liquid from rising via same.

Moreover, the positioning of the balancing tube as described makes it possible, during aeration, to retain the possibility of obtaining the air sheet, while feeding the liquid to be treated via the floor from a deeper zone than the air sheet.

Advantageously, each air chamber forming element displays at the lower edge thereof at least one indentation, each air chamber forming element preferentially displaying four upturned V-shaped indentations regularly distributed on the lower edge thereof.

In this way, it is possible to form medium-sized and/or large bubbles by means of a suitable indentation size, which improves the agitation of the membranes and therefore the unclogging thereof.

According to one advantageous solution, said strainers are fixed in said floor.

The use of the floor makes it possible to facilitate aerating device maintenance operations, the strainers being able to be fixed in a removable manner on the floor. The strainers may be modified or exchanged easily, for example if the gas flow rate needs to be changed. This is not permitted with perforated pipe aerating devices.

Advantageously, said strainers are distributed uniformly on said floor.

It is clearly understood that homogeneous distribution of the clogging gas is provided in this way.

Preferentially, said balancing system comprises a plurality of tubes distributed substantially uniformly on said floor.

The balancing tubes also serving to feed the upper chamber with the liquid to be treated, in this way, a homogeneous distribution of the liquid to be treated in the reactor is obtained, making it possible to distribute the liquid homogeneously on the membranes (thus preventing some from contributing more than others and therefore a heterogeneous loss of efficiency).

Advantageously, said balancing tubes are distributed symmetrically on said floor.

According to a first embodiment, the air chamber of each strainer seals the upper part of each corresponding tubular element, said orifice being provided in the lateral wall of the tube.

According to a second embodiment, the air chamber of each strainer is provided at a distance from each corresponding tubular element, said orifice being provided in the axis thereof.

According to another characteristic, the device forms an independent module.

The invention also relates to an immersed membrane system for water treatment comprising an upper chamber wherein membranes, means for feeding an aerating gas and means for feeding liquid to be treated are installed, characterised in that it is provided with at least one aerating device as described above, said means for feeding an aerating gas and said means for feeding liquid to be treated being provided under said floor of said device.

According to a preferential embodiment, said upper chamber comprises at least one wall with a perforation defining a channel passing therethrough.

Other characteristics and advantages of the invention will emerge more clearly on reading the following description of the two preferential embodiments of the invention, given as illustrative and non-limitative examples, and the appended figures wherein:

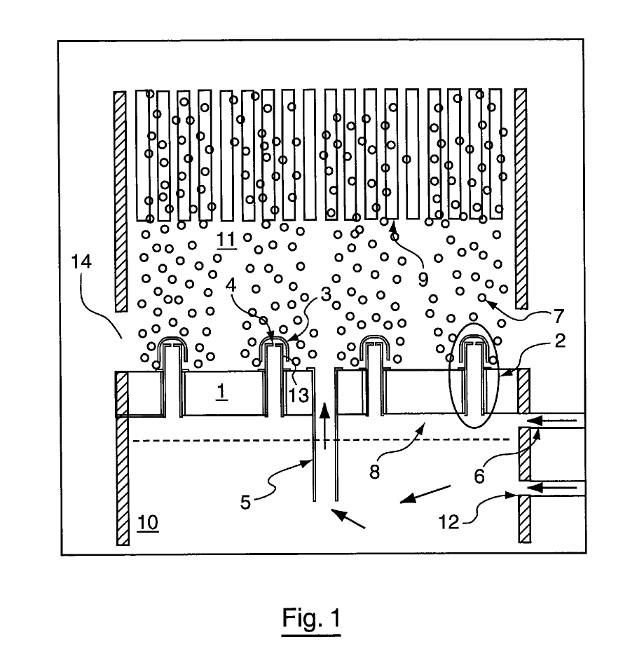

FIG. 1 is a schematic sectional view of a device according to the invention, in the aeration phase;

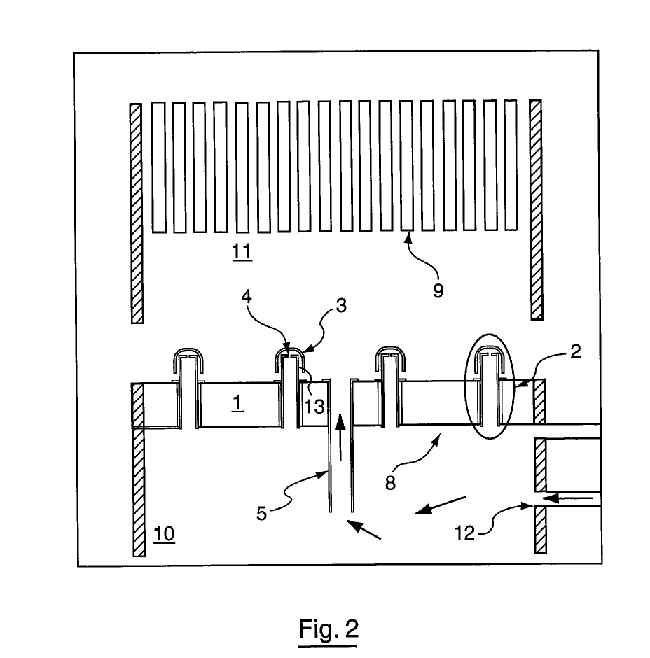

FIG. 2 is a schematic sectional view of a device according to the invention, in the aeration shutdown phase;

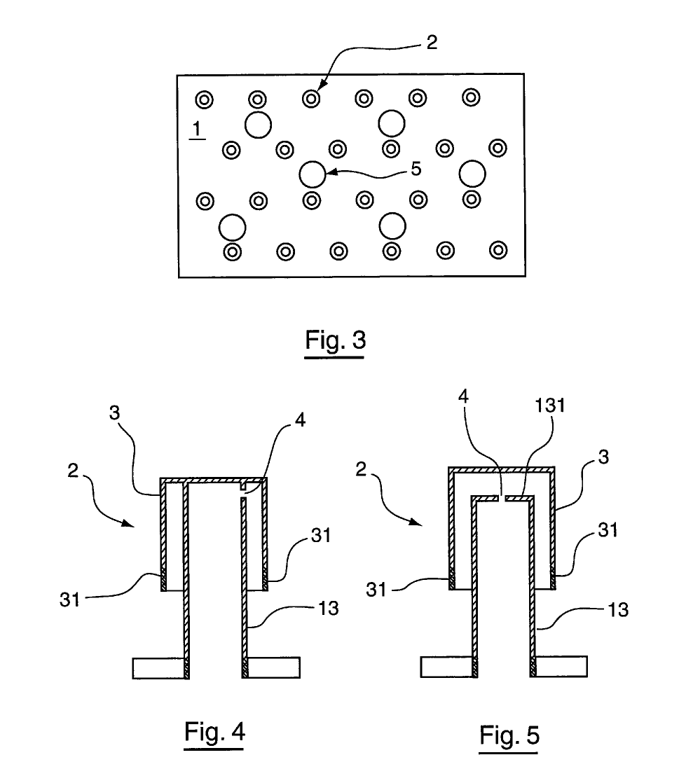

FIG. 3 is a schematic top view of a floor of a device according to the invention;

FIG. 4 is a sectional view of a strainer of a device according the invention, according to a first embodiment;

FIG. 5 is a sectional view of a strainer of a device according to the invention, according to a second embodiment.

As described above, the principle of the invention lies in the design of an aerating device for an immersed membrane reaction in the form of a floor provided with at least one pressure balancing tube between an upper chamber and a lower chamber separated by the floor, strainers wherein the orifices are protected from the liquid to be treated being mounted on the floor.

It is noted that the present invention can be used irrespective of the membrane system used (plane membranes, hollow fibre membranes or tubular membranes) and enables the aeration of all or part of the membranes or one or more modules through the use of an aerating floor equipped with strainers.

Apart from the fact that the aeration system according to the invention makes it possible to limit membrane clogging effectively, its major benefit is that it cannot be blocked despite high sludge concentrations used in the membrane tank (upper chamber).

The operating principle of the aerating floor is illustrated in FIGS. 1 and 2.

The floor 1 consists of a concrete slab or a panel that may consist of other materials (e.g. PVC) arranged in the bioreactor, and an alternation of strainers 2 and balancing tubes 5.

The reactor is thus divided into an upper chamber 11 incorporating membranes 9 and a lower chamber 10 separated by the floor 1.

The injection of liquid to be treated, via a conduit 12, along with the injection of air, via a conduit 6, are performed beneath the aerating floor, in the lower chamber.

The balancing tubes 5 make it possible to allow the liquid to be treated to transit freely, via the floor 1, of the lower chamber 10 to the upper chamber 11 of the floor.

The strainers are used for aerating the membrane modules 9.

As illustrated in FIG. 3, a regular arrangement of the aerating strainers 2 on the floor is provided, so as to provide homogeneous aeration with air of the membrane modules arranged above same. If several balancing tubes are provided, they are also distributed regularly, for example in a staggered fashion. The strainers and balancing tubes may be distributed as shown, the number thereof and the proportion of each possibly varying significantly according to the application used.

As an indication, the strainers are spaced at a distance of approximately 200 mm between each other and the tube 5 by approximately 300 mm. During the air injection (FIG. 1), the pressure drop created by the aerating tube orifice of each strainer makes it possible to maintain an air sheet 8 beneath the floor (1 to 30 cm depending on the injected air flow rate), thus preventing any liquid from rising in the tube.

The air chamber and the presence of small openings at the base thereof, enable homogeneous air distribution, in the form of large bubbles 7.

When the aeration is in operation, the balancing tubes 5 are also used to produce homogeneous distribution of the liquid to be treated (e.g. activated sludge for membrane bioreactors). In this case, the liquid to be treated is injected into the lower chamber by recirculation and then passes through the balancing holes to reach the membrane modules.

When aeration is interrupted (FIG. 2), the air sheet disappears 8, the air escapes via the orifices and both chambers (upper 11 and lower 10) are balanced in terms of pressure by means of the balancing tube (without this balancing tube, the liquid to be treated could be aspirated inside the strainers by means of simple balancing of the pressures and therefore come into contact with the orifices).

Therefore, a quantity of air remains trapped beneath the air chamber and in the aerating tube, over the entire height of the air chamber. This makes it possible to prevent any contact between the liquid to be treated and the orifice of the aerating tube, and therefore eliminate any risk of blockage.

Moreover, when aeration is shut down, the supply of liquid to be treated may be maintained without causing liquid to rise in the aerating strainers, said strainers being protected by the trapped air.

FIGS. 4 and 5 illustrate, in more detail, the strainers 2 consisting of a central tubular element 13 provided at the upper part thereof with an orifice 4, the tube 13 being mounted atop by a cover 3.

According to the embodiment illustrated in FIG. (5), the orifice 4 is provided in the side wall of the tube 13, the cover 3 being in this case mounted directly on the upper end of the tube 13 so as to close same.

According to the embodiment illustrated in FIG. 4, the orifice 4 is provided in the end wall 131 of the tube 13, substantially in the axis thereof. The cover 3 is then removed from the end wall 31 of the tube 13.

It should be noted that the balancing tubes 5 extend beneath the floor 1 so that the lower end thereof opens into a zone of the lower chamber 10 wherein the depth corresponds substantially to the depth of the chamber at which the conduit 12 for feeding the liquid to be treated opens.

In this way, the air injection conduit 6 being positioned above and at a distance from the conduit 12, it is possible to obtain a sufficient air sheet 8 thickness to prevent any risk of liquid rising in the strainers.

Preferentially, the air injection conduit 6 opens directly in the vicinity of the floor 1.

The filtering device including the device according to the invention described above may consist of an independent module.

According to a preferred layout of a water treatment facility, said facility comprises several independent devices equipped with an aerating device, the upper chambers of each device communicating with each other via a channel 14.

1.-13. (canceled)

14. A water treatment system, comprising:
an upper chamber and a lower chamber separated by a partition;
the upper chamber including a plurality of immersed membranes for removing contaminants from the water;
the lower chamber including a gas inlet and a water inlet for directing gas and water respectively into the lower chamber, the water inlet disposed at a lower depth in the lower chamber than the gas inlet;
a plurality of air dispersers extending through the partition from the lower chamber to the upper chamber for directing gas from the lower chamber to the upper chamber to aerate the immersed membranes; and
at least one passageway extending through the partition from the lower chamber to the upper chamber for directing water from the lower chamber to the upper chamber.

15. The system of claim 14 wherein each of the plurality of air dispersers includes at least one orifice disposed in an upper portion of the air disperser.

16. The system of claim 15 wherein each of the plurality of air dispersers includes a cover disposed adjacent to the upper portion of the air disperser.

17. The system of claim 14 wherein the gas inlet and the plurality of air dispersers are configured such that a gas layer forms under the partition and beneath the plurality of air dispersers when gas enters the lower chamber to prevent water from entering the plurality of air dispersers in the lower chamber.

18. The system of claim 16 wherein each cover and air disperser is configured such that gas in the air disperser becomes trapped beneath the cover to prevent water from contacting the orifice in the air disperser in the upper chamber.

19. The system of claim 16 wherein the cover of at least one of the plurality of air dispersers covers a terminal end portion adjacent the upper end portion of the air dispenser and the orifice is disposed in a lateral wall in the upper portion of the air dispenser.

20. The system of claim 14 wherein the immersed membranes are micro-filtration or ultra-filtration membranes.

21. The system of claim 14 wherein the immersed membranes are disposed in a vertical position generally transverse to the partition.

22. The system of claim 14 wherein the passageway extends into the lower chamber such that a lower end portion of the passageway is generally aligned with the water inlet.

23. The system of claim 14 wherein the plurality of air dispersers is movably mounted with respect to the partition.

24. The system of claim 23 wherein the plurality air dispersers is distributed in the partition to provide homogeneous distribution of gas to the immersed membranes.

25. The system of claim 14 wherein:
each of the plurality of air dispersers includes a cover and an orifice;
the cover of at least one of the plurality of air dispensers extends over a terminal end portion of the air dispenser in the upper chamber;
the orifice of at least one of the plurality of air dispensers is disposed on an upper portion of the air disperser; and
wherein each cover and air disperser is configured such that gas in the air disperser becomes trapped beneath the cover to prevent water from contacting the orifice.

26. The system of claim 25 wherein:
the gas inlet and the plurality of air dispersers are configured such that a gas layer forms under the partition and directly beneath the plurality of air dispersers when gas enters the lower chamber to prevent water from entering the plurality of air dispersers in the lower chamber; and
the passageway extends into the lower chamber such that a lower end of the passageway is generally aligned with the water inlet.

27. The system of claim 14 wherein a plurality of passageways extend through the partition from the lower chamber to the upper chamber for directing water from the lower chamber to the upper chamber.

28. The system of claim 27 wherein the plurality of air dispersers are spaced apart from each other by approximately 200 mm and spaced apart from the plurality passageways by approximately 300 mm.

29. The system of claim 14 wherein the system is configured to balance the pressures in the lower and upper chambers.

30. The system of claim 14 wherein the plurality of air diffusers are configured to generate a pressure drop which in turn forms a gas layer under the partition and below the plurality of air diffusers.

31. The system of claim 14 wherein the upper chamber includes a bioreactor.

32. A method of treating water, the method comprising:
directing gas from a gas inlet into a lower chamber and into a plurality of plurality of air dispersers;
directing water to be treated from a water inlet into the lower chamber and into a passageway;
forming a gas layer in the lower chamber below the plurality of air dispersers to prevent water from entering the plurality of air dispersers in the lower chamber;
distributing gas into an upper chamber by directing the gas entering the plurality of air dispersers into the upper chamber;
aerating a plurality of membranes disposed in the upper chamber with the gas distributed in the upper chamber; and
filtering the water with the plurality of membranes disposed in the upper chamber by directing water through the passageway into the upper chamber.

33. The method of claim 32 including directing the gas through an orifice associated with each air disperser which gives rise to a pressure drop which in turn forms the gas layer below the plurality of air dispersers.

34. The method of claim 32 including directing the water to be treated from the lower chamber, via at least one elongated tube into the upper chamber, the elongated tube including an inlet that is disposed below the gas layer.
